(19) United States
(12) Patent Application Publication
(10) Pub. No.: US 2026/0179612 A1
(43) Pub. Date: Jun. 25, 2026

(54) PUBLIC SAFETY VOICE ASSISTANCE FOR ENTERPRISE SYSTEMS

(71) Applicant: MOTOROLA SOLUTIONS, INC., Chicago, IL (US)

(72) Inventors: Srividya G. SUBRAMANYAM, South Barrington, IL (US); Shivangi CHAUDHRI, Chicago, IL (US); Carter SCHEVE, Hoffman Estates, IL (US)

(21) Appl. No.: 18/990,800

(22) Filed: Dec. 20, 2024

(51) Int. Cl. G10L 15/22; G10L 15/30

(52) U.S. Cl. CPC G10L 15/22; G10L 15/30

(57) ABSTRACT

A method for providing public safety voice assistance for enterprise systems is described. The method comprises receiving, at an enterprise assistant, a voice assistance request from an enterprise communication device. Determining, based on its content, that the voice assistance request includes an assistance request component that the virtual enterprise assistant is not competent to answer. Identifying, based on the content, a virtual public safety assistant associated with a public safety agency. A request is transmitted to the virtual public safety assistant. The request includes the assistance request component and enterprise data based on the context of the assistance request component that could aid the virtual public safety assistant formulate a response. The response is received and communicated to the enterprise communication device. A device comprising a processor and a computer-readable storage medium storing instructions that, when executed by the processor, causes the processor to perform the method is also described.

### BACKGROUND

Intelligent voice-based virtual assistants are prevalent in many industries. For example, intelligent voice-based virtual enterprise assistants are capable of assisting users with talk group operations in a retail or other enterprise system. An example of a virtual enterprise assistant is EVA by Motorola Solutions, Inc. Similarly, intelligent voice-based virtual public safety assistants are capable of assisting users with talk group operations in a law enforcement, emergency medical assistance, fire services and the like. An example of a virtual public safety assistant is ViQi® by Motorola Solutions, Inc.

For incidents that intersect enterprise and public safety networks, there may be a need to seek assistance from both the virtual enterprise assistant and the virtual public safety assistant. However, the virtual enterprise assistant and the virtual public safety assistant are trained using different language models, so comprehension is an issue.

As a result of the comprehension issues between the virtual assistants, there is an inefficiency in providing information for, and resolving incidents in the enterprise space.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of an example system for providing public safety voice assistance for enterprise systems.

FIG. 2 is a block diagram of an example of an enterprise computer.

FIG. 3 is a flowchart representative of a general method for providing public safety voice assistance for enterprise systems.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In accordance with an aspect of the present specification, there is provided a method comprising: receiving, at an intelligent voice-based virtual enterprise assistant of an enterprise, a first voice assistance request from an enterprise radio; determining, based on a content of the first voice assistance request, that the first voice assistance request includes a public safety agency assistance request component that the virtual enterprise assistant is not competent to answer; identifying, based at least in part on the content of the first voice assistance request, an available intelligent voice-based virtual public safety assistant associated with a public safety agency tasked with providing a public safety agency response to the enterprise; transmitting a request to the virtual public safety assistant, the request including: the public safety agency assistance request component, and enterprise context associated with the public safety agency assistance request component determined by the virtual enterprise assistant that could aid the virtual public safety assistant in formulating the public safety agency response; and receiving the public safety agency response from the virtual public safety assistant based; and communicating the public safety agency response to the enterprise radio. The virtual public safety assistant may be identified based on a location of the enterprise.

The public safety response may be modified based on additional enterprise context of the enterprise safety assistant, prior to communicating the response to the enterprise communication device. The public safety response may include a machine-learning generated response from the virtual public safety assistant and a user generated response from a public safety communication device. The virtual public safety assistant may be instructed to request the user of the public safety communication device provide physical assistance to a user of the enterprise communication device.

The public safety response may be filtered at the virtual public safety assistant to remove predefined sensitive public safety agency information prior to transmitting the public safety response to the virtual enterprise assistant.

Additional enterprise context of the first voice assistance request may be processed and transmitted to the virtual public safety assistant.

The virtual enterprise assistant may use an enterprise language model. The virtual public safety assistant may use a public safety language model different to the enterprise language model. The virtual public safety assistant uses the public safety language model to process the public safety agency assistance request component. The first voice assistance request is received from the enterprise communication device over a radio communication channel. An Internet Protocol (IP) based connection is established with the virtual public safety assistant. An enterprise assistance request component to be handled by the virtual enterprise assistant is determined. The public safety agency assistance request component to be transmitted to the virtual public safety assistant via the IP based connection is also determined.

Information related to the public safety agency may be deleted upon completion of the first voice assistance request.

In accordance with another aspect of the present specification, a device is provided comprising a processor and a computer readable medium having stored thereon program instructions that, when executed by the processor, cause the processor to perform a set of operations comprising the method described above.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

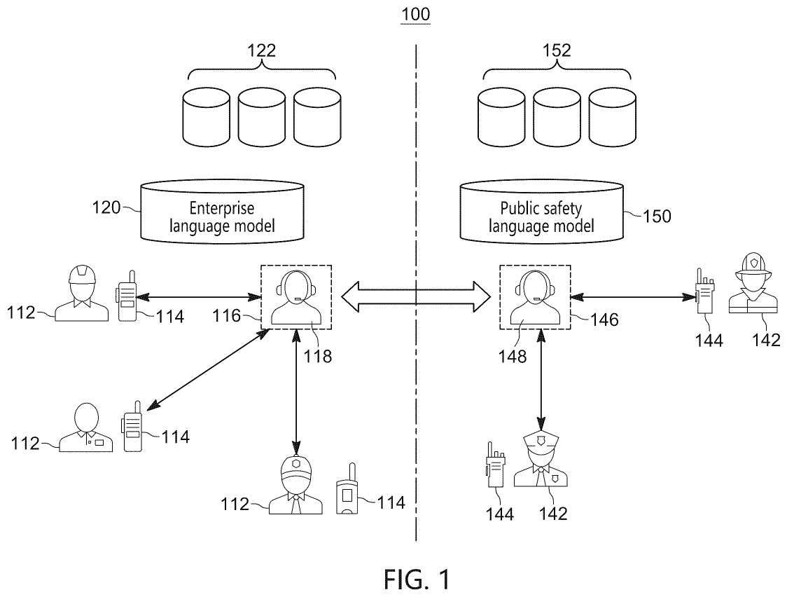

Referring to FIG. 1, an example system for providing public safety voice assistance for enterprise systems is illustrated generally by numeral 100. The system includes an enterprise 110 and a public safety system 140.

The enterprise 110 includes a plurality of enterprise users 112, a plurality of enterprise communication devices 114, and an enterprise computer 116. The enterprise computer 116 hosts an intelligent voice-based virtual enterprise assistant 118 for the enterprise 110. The virtual enterprise assistant 118 is deployed based on an enterprise language model 120. A plurality of enterprise language datasets 122 are available to train and support the enterprise language model 120.

The enterprise users 112 can include security personnel, managers, health and safety personnel, or other users employed by the enterprise. In some embodiments, the virtual enterprise assistant 118 serves only the enterprise users 112 for a single enterprise. In some embodiments, the virtual enterprise assistant 118 serves the enterprise users 112 of multiple, different enterprises. For example, the same virtual enterprise assistant 118 may serve a private factory, a retail store, and a retail warehouse, among other possibilities.

The enterprise communication devices 114 facilitate communication between the enterprise users 112 and the virtual enterprise assistant 118. In some embodiments, the enterprise communication devices 114 are portable two-way professional and commercial radios (PCRs). PCR refers to handheld, portable radios used for two-way voice communication. They are commonly called “walkie-talkies.” In some embodiments, the enterprise communication devices 114 are portable computing devices. If the portable computing devices provide generic computing operations, they can be loaded with an application to facilitate communication with the virtual enterprise assistant 118. For example, tablets, smart phones, smart watches, wearable audio devices, and the like can be configured by loading the application to facilitate communication with the virtual enterprise assistant 118. If the portable computing devices are purpose-built devices, they may be pre-configured to communicate with the virtual enterprise assistant 118. For example, a portable voice assistant may be pre-configured to communicate with the virtual enterprise assistant 118. Such devices may require only that the enterprise users enter the settings for the virtual enterprise assistant 118. The enterprise communication devices 114 used by an enterprise may be all the same type or they may be a mix of PCRs and portable computing devices.

The enterprise language model 120 is created to serve the enterprise 110. Language models are designed to understand, predict, and generate human language. They work by analyzing patterns and structures. Accordingly, the enterprise language model 120 is trained using the enterprise language datasets 122 and deployed using the virtual enterprise assistant 118.

The enterprise language datasets 122 provide a collection of data and language-related information that is used to train and support the enterprise language model 120. The enterprise language datasets 122 may include human-generated or machine-generated language examples, tailored to specific tasks for the virtual enterprise assistant 118. The tasks may include text generation, translation, classification, and understanding. There may be different enterprise language datasets 122 for each of the different enterprises, as the enterprises may have different needs. Thus, continuing the previous example, the enterprise language datasets 122 may include a private factory dataset, a retail store dataset, and/or a retail warehouse dataset. In some embodiments, the enterprise language model 120 is trained on all the available enterprise language datasets 122.

The public safety system 140 includes a plurality of public safety users 142, a plurality of public safety communication devices 144, and a public safety computer 146. The public safety computer 146 hosts an intelligent voice-based virtual public safety assistant 148 for the public safety system 140. The virtual public safety assistant 148 is deployed based on a public safety language model 150. A plurality of public safety language datasets 152 are available to train and support the public safety language model 150.

The public safety users 142 can include law enforcement officers, firefighters, emergency medical personnel and the like. The virtual public safety assistant 148 serves a predefined region. In some embodiments, the virtual public safety assistant 148 is available to all the public safety users 142 within the region. Thus, different virtual public safety assistants 148 serve different regions. In some embodiments, there is some overlap between adjacent regions. In some embodiments, there is no overlap between different regions. In some embodiments, the virtual public safety assistant 148 is available to specific types of the public safety users 142 within the region. That is, a virtual law enforcement assistant is available to law enforcement officers, a virtual fire assistant is available to firefighters, and a virtual medical assistant is available to emergency medical personnel.

The public safety communication devices 144 facilitate communication between the public safety users 142 and the virtual public safety assistant 148. In some embodiments, the public safety communication devices 144 are Land Mobile Radios (LMRs). LMR encompasses professional-grade radio systems used for communication over land. These systems are often part of a network that includes base stations, repeaters, and dispatch consoles. In some embodiments, the public safety communication devices 144 include portable computing devices. If the portable computing devices provide generic computing operations, they can be loaded with an application to facilitate communication with the virtual public safety assistant 148. For example, tablets, smart phones, smart watches, wearable audio devices, and the like can be configured by loading the application to facilitate communication with the virtual public safety assistant 148. If the portable computing devices are purpose-built devices, they may be pre-configured to communicate with the virtual public safety assistant 148. For example, a portable voice assistant may be pre-configured to communicate with the virtual public safety assistant 148. Such devices may require only that the public safety users 142 configure the settings for the virtual public safety assistant 148. The public safety communication devices 144 used by a public safety agency may be all the same type or they may be a mix of LMRs and portable computing devices.

The public safety language model 150 is created to serve the public safety system 140. The public safety language model 150 is trained using the public safety language datasets 152 and deployed using the virtual public safety assistant 148.

The public safety language datasets 152 provide a collection of data and language-related information that is used to train the public safety language model 150. The public safety language datasets 152 may include human-generated or machine-generated language examples, tailored to specific tasks for the public safety enterprise assistant. The tasks may include text generation, translation, classification, and understanding. There may be different public safety language datasets 152 for each of the different public safety agencies, as the public safety agencies may have different needs. Thus, continuing the previous example, the public safety datasets 152 may include a law enforcement dataset, a fire dataset, and a medical services dataset. In some embodiments, the public safety language model 150 is trained on all the available public safety language datasets 152.

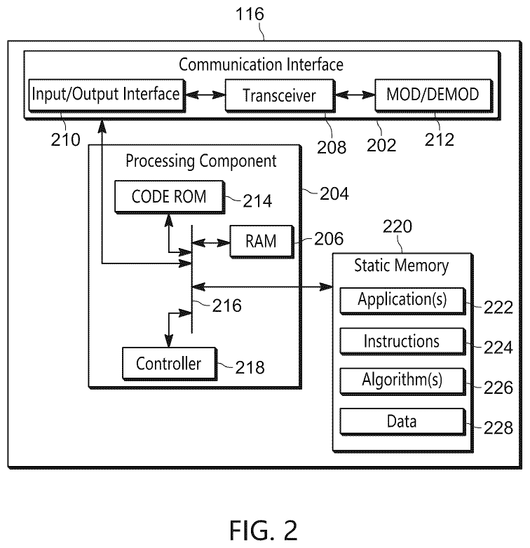

Referring to FIG. 2, a schematic block diagram of an example of the enterprise computer 116 is illustrated generally by numeral 200. The enterprise computer 116 may include a communication interface 202, a processing component 204, and a memory 220. The public safety computer 146 may include a same or similar structure.

The communication interface 202 includes one or more transceivers 208, input/output (I/O) interfaces 210, and modems 212. The I/O interfaces 210 may include one or more wired and/or wireless interfaces that are configurable to communicate with suitable components of the enterprise computer 116. For example, the I/O interfaces 210 may interface with a peripheral device such as a touchscreen, keyboard, camera, mouse, and the like.

The one or more transceivers 208 may be adapted for communication with the enterprise communication devices 114. For example, the one or more transceivers 208 may be adapted for communication with one or more of a PCR network, the Internet, a Bluetooth network, a Wi-Fi network, for example operating in accordance with the IEEE 802.11 standards, an LTE (Long-Term Evolution) network and/or other types of GSM (Global System for Mobile communications) and/or 3GPP (3rd Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network.

Hence, the one or more transceivers 208 may include a PCR transceiver, a cell phone transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

The communication interface 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to the modem 212.

The processing component 204 may include a Read Only Memory (ROM) 214, a Random Access Memory (RAM) 206, a common data and address bus 216 and a controller 218. The ROM 214, the RAM 206, and the controller 218 are communicatively coupled to the common data and address bus 216. Further, the communication interface 202 and the memory 220 are communicatively coupled to the processing component 204 via the common data and address bus 216.

The controller 218 may include one or more logic circuits, one or more processors, one or more microprocessors, one or more GPUs (Graphics Processing Units), and/or the controller 218 may include one or more ASIC (application-specific integrated circuits) and one or more FPGA (field-programmable gate arrays), and/or another electronic device.

The memory 220 provides a non-transitory computer readable medium for storing machine readable instructions to implement one or more programs or applications 222, instructions or program code 224, algorithms 226, and/or application data 228. While the instruction or program code, 224, algorithms 226, and the application data 228 are shown as being separate from the applications 222, they may be components of the applications 222.

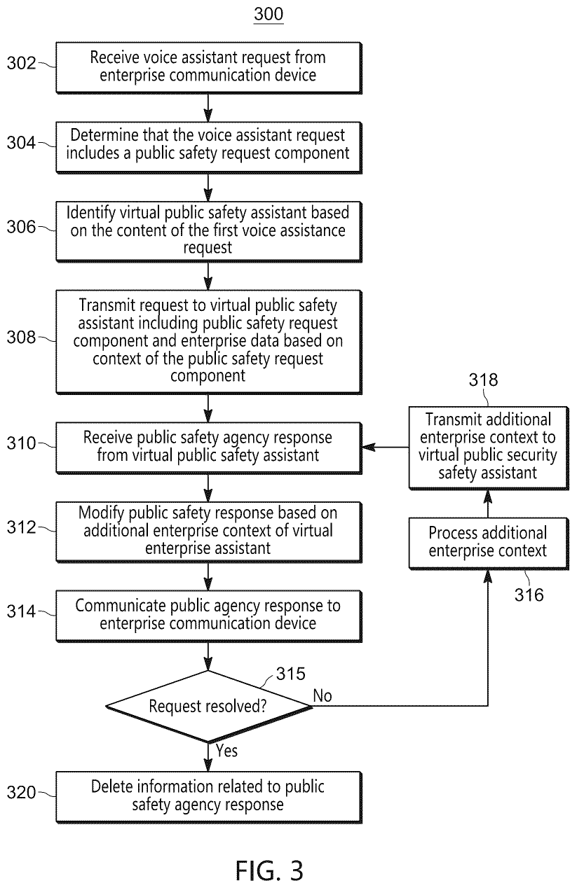

Thus, for example, the memory 220 stores instructions and/or program code 224 and/or algorithms 226 and/or application data 228 corresponding to the at least one application 222 that, when executed by the controller 218, enables the controller 218 to implement functionality for real-time situational media integration, including but not limited to, the blocks of the method set forth in FIG. 3.

Put another way, the memory 220 may comprise a non-transitory computer-readable storage medium having stored thereon program instructions that, when executed by the controller 218, cause the controller 218 to perform a set of operations comprising some or all of the blocks of the method set forth in FIG. 3.

The application 222 and/or one or more of the algorithms 226 may include programmatic algorithms, and the like, to implement functionality as described herein.

Alternatively, and/or in addition to programmatic algorithms, the application and/or the one or more of the algorithms may include one or more machine learning algorithms to implement functionality as described herein.

The one or more machine learning algorithms of the application and/or the algorithms may include, but are not limited to: a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, and the like. Any suitable machine learning algorithm and/or deep learning algorithm and/or neural network is within the scope of present examples.

Furthermore, in examples where the application 222 and/or the one or more of the algorithms 226 includes one or more machine learning algorithms, the application 222 and/or the one or more of the algorithms 226 may be operated in a training mode to train the application 222 and/or the one or more of the algorithms 2226 to implement the functionality described herein.

Referring to FIG. 3, a flowchart representative of a general method for providing public safety voice assistance for enterprise systems is illustrated generally by numeral 300. Examples illustrating the method are described afterwards. The operation of the methods corresponds to machine readable instructions that are executed by the controller 218. In the illustrated examples, the instructions represented by the blocks are stored at the memory 220 for example, as the application 222 and/or the algorithms 226. The methods are some ways in which the controller 218 may be configured. Furthermore, the following discussion of the methods will lead to a further understanding of the system 100 and its various components.

The methods need not be performed in the exact sequence as shown and likewise various blocks may be performed in parallel rather than in sequence. Accordingly, the elements of the methods are referred to herein as “blocks” rather than “steps”. The methods may be implemented on variations of the system 100 of FIG. 1, as well.

Furthermore, in the description of the methods, reference is made to at least one computing device performing the method as functionality indicated by the method may be performed in a distributed manner.

At block 302, the virtual enterprise assistant 118 of the enterprise 110 receives a first voice assistance request from the enterprise communication device 114. At block 304, based on content of the first voice assistance request, it is determined that the first voice assistance request includes a public safety agency assistance request component that the virtual enterprise assistant 118 is not competent to answer. For example, the virtual enterprise assistant 118 may determine that, based on the context of the public safety agency assistance request component, that other language models are better suited to address the request. For example, the virtual enterprise assistant 118 may have access to a list of available virtual public safety assistants 148 and their related expertise. In another example, the virtual enterprise assistant 118 may broadcast an inquiry to the available virtual public safety assistants 148 to determine which ones have the necessary expertise to formulate a response to public safety agency assistance request component.

In some embodiments, the first voice assistance request includes an enterprise assistance request component as well as the public safety agency assistance request component. The enterprise assistance request components are handled by the virtual enterprise assistant 118 and the public safety agency assistance request component to be transmitted to the virtual public safety assistant 148.

At block 306, an available virtual public safety assistant 148 is identified, at least in part on the content of the first voice assistance request. The virtual public safety assistant 148 is associated with a public safety agency tasked with providing a public safety agency response to the enterprise. In some embodiments, if the content of the first voice assistance request indicates that a physical response may be required, the virtual public safety assistant 148 is identified based on a location of the enterprise 110. For example, the identified virtual public safety assistant 148 may be associated with the law enforcement, fire, and emergency medical services local to the enterprise 110. In some embodiments, if the content of the first voice assistance request indicates the need for a particular public safety expertise, the virtual public safety assistant 148 is identified based on the content of the public safety language model 150 on which the virtual public safety assistant 148 is selected. For example, in the case of a chemical spill, a virtual public safety assistant 148 is selected for a public safety language model 150 trained on data related to handling chemical spills. In some embodiments, the virtual public safety assistant 148 is identified based on a combination of the location of the enterprise and the expertise of the virtual public safety assistant 148.

At block 308, a request is transmitted to the virtual public safety assistant 148. In some an Internet Protocol (IP) based connection is established between the virtual enterprise assistant 118 and the virtual public safety assistant 148, and the request is communicated using the IP based connection. The request includes the public safety agency assistance request component. The request also includes enterprise data based on the context of the public safety agency assistance request component. The enterprise context is determined by the virtual enterprise assistant 118 to be able to aid the virtual public safety assistant 148 in formulating the public safety agency response. In some embodiments, the request further instructs the virtual public safety assistant 148 to request a user 142 of the public safety communication device 144 provide physical assistance to the user 112 of the enterprise communication device 114.

At block 310, the public safety agency response is received from the virtual public safety assistant 148. The public safety agency response is generated by the virtual public safety assistant 148 using the public safety agency language model 150 to process the public safety agency assistance request component. In some embodiments the public safety response includes a machine-learning generated response from the virtual public safety assistant 148. In some embodiments, the public safety response further includes a response generated by one or more of the public safety users 142 of the public safety communication devices 144, or a combination of the foregoing.

In some embodiments, the public safety response is filtered at the virtual public safety assistant 148 to remove predefined sensitive public safety agency information prior to transmitting the public safety response to the virtual enterprise assistant 118. For example, the virtual public safety assistant 148 may have access to information that should only be accessible to public service agencies and the public safety responders 142. Such information is filtered prior to sending the public safety response to avoid the likelihood of divulging confidential or otherwise sensitive information. The information may be abstracted or anonymized so that it is still informative for the enterprise users 112.

In some embodiments, at block 312 once the public safety response is received, it is modified based on additional enterprise context of the enterprise safety assistant. At block 314, the public safety agency response is communicated to the enterprise communication device 114.

At block 315, it is determined whether or not the public safety agency assistance request component has been resolved. If it has not been resolved, then at block 316 additional enterprise context of the voice assistance request is processed by the virtual enterprise assistance 118. For example, the enterprise user 112 may communicate more information about the public safety agency assistance request component as it becomes available. At block 318, the virtual enterprise assistant 118 transmits the additional enterprise context to the virtual public safety assistant 148.

Returning to block 314, if the public safety agency assistance request component has been resolved, then at block 320 information related to the public safety agency response is deleted. Deleting the information inhibits the information from becoming stale or outdated and then accidentally relied upon by the enterprise virtual assistant or by the enterprise users 112 in the future.

Examples illustrated the method above are described as follows. In a first example, the enterprise 110 is an industrial plant and the public safety agency assistance request component is a mention of chemical spill. At block 302, the virtual enterprise assistant 118 receives the voice assistance request from a plant worker 112 via the PCR. In this example, the voice assistance request is “There is a toxic spill and we are having breathing issues on aisle 9. What is your recommendation?”

At block 304, the virtual enterprise assistant 118 recognizes that assistance from a public safety agency is critical to properly servicing the request. Specifically, the virtual enterprise assistant 118 could benefit from fire and medical expertise in the public safety language model 150 that is accessible to the virtual public safety assistant 148.

The inclusion of “toxic spill” and “breathing issues” causes the virtual enterprise assistant 118 to determine that the voice assistance request includes a public safety agency assistance request component. The public safety request component may result in a request for emergency assistance in responding to the toxic spill, as described below. The same request may also have enterprise assistance request components. For example, the inclusion of “toxic spill” and “aisle 9” may result in a request for enterprise supervision by a health and safety expert and/or a manager responsible for the identified aisle.

At block 306, a virtual public safety assistant 148 associated with a fire department local to the plant is identified. In this example, the virtual public safety assistant 148 is identified because of the proximity of the fire department to the plant. Further, the virtual public safety assistant 148 is identified because it has the necessary expertise for chemical spills. For example, the virtual enterprise assistant 118 may have access to a list of available virtual public safety assistants 148 and their related expertise. In another example, the virtual enterprise assistant 118 may broadcast an inquiry to the available virtual public safety assistants 148 to determine which ones have the necessary expertise for chemical spills.

At block 308, a request is transmitted to the virtual public safety assistant 148. The request includes the public safety agency assistance request component. The request also includes enterprise data based on the context of the public safety agency assistance request component. In this example, the context of the public safety agency assistance request component includes “Toxic spill”, “breathing issue”, and “aisle 9”. The qualifiers for the context are CAUSE, SYMPTOM, LOCATION. The enterprise data for the context includes physical location information (Aisle=9, Nearest dock=1342, Closest Entry=South side, Closest First Aid Kit=Aisle 10), chemical identification (Chemical X, Trace Chemical=Chlorine), and the occupancy of the industrial warehouse (100 people in the building), among other possibilities.

In response to this information, the virtual public safety assistant 148 formulates a response “Do you have access to Steroid Y? Recommend opening the victim's mouth and administer 1 oz of the steroid.” At block 310, the response is received by the virtual enterprise assistant 118

In some embodiments, the public safety response is filtered to remove sensitive information. Sensitive information may be filtered by being removed entirely, abstracted, or anonymized. For example, the location and identity of the public safety user 142 may be withheld from the virtual enterprise assistant 118 for privacy reasons. Some public safety information may also be abstracted from the virtual enterprise assistant 118 for safety reasons. For example, some or all the details of the adverse effects of the chemical involved in the chemical spill may be abstracted to a general level to reduce the likelihood of causing a panic.

At block 312, the public safety response may be modified by the virtual enterprise assistant 118. For example, if the public safety response instructs using an automated external defibrillator (AED), the virtual 118 enterprise assistant may supplement that response with an indication of the location of the nearest AED.

At block 314, the public safety response is communicated to the PCR 114 of the plant worker 112. At block 315, it is determined whether or not the public safety agency assistance request component has been resolved. In this example, it is determined if the incident is over, the toxic spill has been cleared, and the victims have been attended to. While the public safety agency assistance request is ongoing, at block 316 additional enterprise context of the voice assistance request is processed by the virtual enterprise assistant 118. For example, additional details may be provided by the plant worker 112 as they become available, such as the size of the spill, an improvement or decline in the condition of the condition of the victim, among other things. At block 318, the additional details are transmitted to the virtual public safety assistant 148.

In some embodiments, the response of the virtual public safety assistant 148 is also communicated to the public safety communication device 144 of the public safety user 142 for additional input. The response is formulated as “Industrial incident at Enterprise. Aisle 9 has Chemical X—traces of Chlorine. Recommendation provided to administer steroid by mouth to victims with breathing issue.” The public safety user 142 can supplement the response of the virtual public safety assistant 148 by suggesting “It is recommended to keep the head upright while administering the steroid.” The virtual public safety assistant 148 further communicates the user generated response to the virtual enterprise assistant 118.

In some embodiments, the virtual enterprise assistant 118 instructs the virtual public safety assistant 148 to request the user of the public safety communication device 144 attend the industrial plant in person. The physical location information (Aisle=9, Nearest dock=1342, Closest Entry=South side) shared by the virtual enterprise assistant 118 with the virtual public safety assistant 148 allows the virtual public safety assistant 148 to effectively and efficiently direct the user 142 of the public safety communication device 144 to the correct location.

In a second example, the enterprise 110 is a retail store and the public safety agency assistance request component is a mention of an abandoned vehicle. At block 302, the virtual enterprise assistant 118 receives the voice assistance request from a security guard 112 via the PCR. In this example, the voice assistance request is “There is an abandoned car in the parking lot—Illinois license plate CAT2376. What is your recommendation?”

At block 304. the virtual enterprise assistant 118 recognizes that assistance from a public safety agency is critical to properly servicing the request. Specifically, the virtual enterprise assistant 118 could benefit from law enforcement expertise in the public safety language model 150 that is accessible to the virtual public safety assistant 148.

The inclusion of “abandoned car” and “Illinois license plate” causes the virtual enterprise assistant 118 to determine that the voice assistance request includes a public safety agency assistance request component.

At block 306, a virtual public safety assistant 148 associated with a police station local to the retail store is identified. In this example, the virtual public safety assistant 148 is identified only because of the proximity of the police station to the retail store, as a quick response is the most important factor.

At block 308, a request is transmitted to the virtual public safety assistant 148. The request includes the public safety agency assistance request component. The request also includes enterprise data based on the context of the public safety agency assistance request component. In this example, the context of the public safety agency assistance request component includes “abandoned car”, “Illinois license plate”, and “CAT2376”. The qualifiers for the context are CAUSE, SYMPTOM, LOCATION. The enterprise data for the context includes physical location information (Retail Store Parking lot, East side), observation (abandoned), and the occupancy of the parking lot (several vehicles in the parking lot and customers in the vicinity).

In response to this information, the virtual public safety assistant 148 formulates a response “Request security team to vacate the section of the lot in a controlled manner. Abandoned car is a stolen property.” At block 310, the response is received by the virtual public safety assistant 148

In some embodiments, the public safety response is filtered to remove sensitive information. In this example, the location of the public safety user 142 may be presented to the security guard 112, but the parts of their identity may be withheld for privacy reasons. Some public safety information may also be anonymized from the virtual enterprise assistant 118 for privacy reasons. For example, although the vehicle is identified as being stolen, the name of the owner of the vehicle is not provided. Further, the history of the vehicle may be likewise withheld from the virtual enterprise assistant 118 for privacy reasons.

At block 314, the public safety response is communicated to the PCR 114 of the security guard 112. At block 315, it is determined whether or not the public safety agency assistance request component has been resolved. In this example, it is determined if the incident is over and the vehicle has been removed. While the public safety agency assistance request is ongoing, at block 316 additional enterprise context of the voice assistance request is processed by the virtual enterprise assistant 118. For example, additional details may be provided by the security guard 112 as they become available, such as condition of the vehicle, any visible contents in the vehicle, any suspicious people in the parking lot, among other things. At block 318, the additional details are transmitted to the virtual public safety assistant 148.

In some embodiments, the response of the virtual public safety assistant 148 is also communicated to the public safety communication device 144 of the public safety user 142 for additional input. The response is formulated as “License plate CAT2376 is stolen and the perpetrator is at large. Relaying to Retail Store personnel to vacate the section of the lot.” The public safety user 142 can supplement the response of the virtual public safety assistant 148 by suggesting “Vacate and add a barricade around the lot.” The virtual public safety assistant 148 further communicates the user generated response to the virtual enterprise assistant 118.

In some embodiments, the virtual enterprise assistant 118 instructs the virtual public safety assistant 148 to request the user of the public safety communication device 144 attend the retail store in person. The physical location information (Parking lot, East side) shared by the virtual enterprise assistant 118 with the virtual public safety assistant 148 allows the virtual public safety assistant 148 to effectively and efficiently direct the user of the public safety communication device 144 to the correct location.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to three or more subsequently defined options such as “one of A, B, and C” should be construed to mean an existence of any one of the options in the list alone (e.g., A alone, B alone, or C alone) or any combination of the three or more of the options in the list (e.g., A and B and C together, A and B together, A and C together, or B and C together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

What is claimed is:

1. A method comprising:
receiving, at an intelligent voice-based virtual enterprise assistant of an enterprise, a first voice assistance request from an enterprise communication device;
determining, based on a content of the first voice assistance request, that the first voice assistance request includes a public safety agency assistance request component that the virtual enterprise assistant is not competent to answer;
identifying, based at least in part on the content of the first voice assistance request, an intelligent voice-based virtual public safety assistant associated with a public safety agency tasked with providing a public safety agency response to the enterprise;
transmitting a request to the virtual public safety assistant, the request including:
the public safety agency assistance request component, and
enterprise data based on the context of the public safety agency assistance request component determined by the virtual enterprise assistant that could aid the virtual public safety assistant in formulating the public safety agency response;
receiving the public safety agency response from the virtual public safety assistant; and
communicating the public safety agency response to the enterprise communication device.

2. The method of claim 1 further comprising modifying the public safety response based on additional enterprise context of the enterprise safety assistant, prior to communicating the response to the enterprise communication device.

3. The method of claim 1 wherein the public safety response includes a machine-learning generated response from the virtual public safety assistant and a user generated response from a public safety communication device.

4. The method of claim 1, further comprising filtering the public safety response at the virtual public safety assistant to remove predefined sensitive public safety agency information prior to transmitting the public safety response to the virtual enterprise assistant.

5. The method of claim 1, further comprising:
processing additional enterprise context of the first voice assistance request; and
transmitting, to the virtual public safety assistant, the additional enterprise context.

6. The method of claim 1, further comprising:
using, by the virtual enterprise assistant, an enterprise language model;
using, by the virtual public safety assistant, a public safety language model different to the enterprise language model; and
using, by the virtual public safety assistant, the public safety language model to process the public safety agency assistance request component.

7. The method of claim 1, further comprising:
receiving the first voice assistance request from the enterprise communication device over a radio communication channel;
establishing an Internet Protocol (IP) based connection with the virtual public safety assistant; and
determining an enterprise assistance request component to be handled by the virtual enterprise assistant and the public safety agency assistance request component to be transmitted to the virtual public safety assistant via the IP based connection.

8. The method of claim 3, further comprising instructing the virtual public safety assistant to request the user of the public safety communication device provide physical assistance to a user of the enterprise communication device.

9. The method of claim 1, further comprising deleting information related to the public safety agency response upon completion of the first voice assistance request.

10. The method of claim 6, wherein the virtual public safety assistant is identified based on a location of the enterprise, content of the public safety language model on which the virtual public safety assistant is deployed, or a combination thereof.

11. A device comprising:
a processor; and
a computer readable medium having stored thereon program instructions that, when executed by the processor, cause the processor to perform a set of operations comprising:
receiving, at an intelligent voice-based virtual enterprise assistant of an enterprise, a first voice assistance request from an enterprise communication device;
determining, based on a content of the first voice assistance request, that the first voice assistance request includes a public safety agency assistance request component that the virtual enterprise assistant is not competent to answer;
identifying, based at least in part on the content of the first voice assistance request, an intelligent voice-based virtual public safety assistant associated with a public safety agency tasked with providing a public safety agency response to the enterprise;
transmitting a request to the virtual public safety assistant, the request including:
the public safety agency assistance request component, and
enterprise data based on the context of the public safety agency assistance request component determined by the virtual enterprise assistant that could aid the virtual public safety assistant in formulating the public safety agency response;
receiving the public safety agency response from the virtual public safety assistant; and
communicating the public safety agency response to the enterprise communication device.

12. The device of claim 11, the set of operations further comprising modifying the public safety response based on additional enterprise context of the enterprise safety assistant, prior to communicating the response to the enterprise communication device.

13. The device of claim 11 wherein the public safety response includes a machine-learning generated response from the virtual public safety assistant and a user generated response from a public safety communication device.

14. The device of claim 11, the set of operations further comprising filtering the public safety response at the virtual public safety assistant to remove predefined sensitive public safety agency information prior to transmitting the public safety response to the virtual enterprise assistant.

15. The device of claim 11, the set of operations further comprising:
processing additional enterprise context of the first voice assistance request; and
transmitting, to the virtual public safety assistant, the additional enterprise context.

16. The device of claim 11, the set of operations further comprising:
using, by the virtual enterprise assistant, an enterprise language model;
using, by the virtual public safety assistant, a public safety language model different to the enterprise language model; and
using, by the virtual public safety assistant, the public safety language model to process the public safety agency assistance request component.

17. The device of claim 11, the set of operations further comprising:
receiving the first voice assistance request from the enterprise communication device over a radio communication channel;
establishing an Internet Protocol (IP) based connection with the virtual public safety assistant; and
determining an enterprise assistance request component to be handled by the virtual enterprise assistant and the public safety agency assistance request component to be transmitted to the virtual public safety assistant via the IP based connection.

18. The device of claim 13, the set of operations further comprising instructing the virtual public safety assistant to request the user of the public safety communication device provide physical assistance to a user of the enterprise communication device.

19. The device of claim 13, the set of operations further comprising deleting information related to the public safety agency response upon completion of the first voice assistance request.

20. The method of claim 16, wherein the virtual public safety assistant is identified based on a location of the enterprise, content of the public safety language model on which the virtual public safety assistant is deployed, or a combination thereof.
